(19) United States
(12) Patent Application Publication
(10) Pub. No.: US 2004/0038739 A1
(43) Pub. Date: Feb. 26, 2004

(54) Computer game with emotion-based character interaction

(76) Inventor: Peter Wanat, Studio City, CA (US)

Correspondence Address: KOLISCH HARTWELL, P.C., 520 S.W. YAMHILL STREET, SUITE 200, PORTLAND, OR, 97204, US

(21) Appl. No.: 10/645,476

(22) Filed: Aug. 20, 2003

Related U.S. Application Data
(60) Provisional application No. 60/405,066, filed on Aug. 20, 2002.

(51) Int. Cl. A63F 13/00

(52) U.S. Cl. 463/36; 463/30

(57) ABSTRACT

A system and method for use in controlling character interactions in a computer game. The method typically includes providing a squad of user-commandable characters. The squad typically includes a player character and a non-player character, the non-player character being commandable via the player character. The method further typically includes detecting a predefined game event, adjusting a current emotional state of the non-player character based on the game event, and selecting a non-player character reaction based on the current emotional state of the non-player character.

### CROSS REFERENCE TO RELATED APPLICATION

This application claims priority under 35 U.S.C. § 119 to U.S. Provisional Patent Application Serial No. 60/405,066 of Peter Wanat, entitled “COMPUTER GAME WITH EMOTION-BASED CHARACTER INTERACTION,” which was filed on Aug. 20, 2002, the entire disclosure of which is hereby incorporated by reference for all purposes.

### TECHNICAL FIELD

The present invention relates generally to computer games, and more particularly to squad-based computer games with emotion-based character interaction.

### BACKGROUND

In many computer games, a player controls a character in first-person perspective, slaying monsters and solving puzzles in order to advance through a series of increasingly difficult levels. Since this type of game relies primarily on first-person interaction with enemies and puzzles, these games often appear very similar to each other, and game players who play a number of these games can become bored over time.

Recently, a new type of computer game has emerged in which a player-controlled character acts as a leader of a squad of non-player controlled characters, commanded by the computer. These prior art squad-based games have the advantage over non-squad based games that the player may use the assistance of non-player characters to accomplish tasks in the game, such as defeating a large monster. But, current squad-based games suffer from the problem that interaction between the non-player characters and the player-controlled character is lackluster and predictable, because the non-player characters operate as automaton-like servants of the player-controlled character. This makes for uninteresting game-play, and may bring about the end of the squad-based game genre unless improvements are made.

### SUMMARY OF THE INVENTION

A system and method for use in controlling character interactions in a computer game are provided. The method typically includes providing a squad of user-commandable characters. The squad typically includes a player character and a non-player character, the non-player character being commandable via the player character. The method further typically includes detecting a predefined game event, adjusting a current emotional state of the non-player character based on the game event, and selecting a non-player character reaction based on the current emotional state of the non-player character.

### BRIEF DESCRIPTION OF THE DRAWINGS

FIG. 1 is a schematic view of a computer game system according to one embodiment of the present invention.

FIG. 2 is a schematic view of a software architecture of a computer game program of the system of FIG. 1.

FIG. 3 is a schematic view of a graphical user interface of a computer game program of the system of FIG. 1.

FIG. 4 is a schematic view of a real-time game play interface of the graphical user interface of FIG. 2.

FIG. 5 is a schematic view of fear indicators displayed on the graphical user interface of FIG. 2.

FIG. 6 is a schematic view of a non-player character interface of the graphical user interface of FIG. 2.

FIG. 7 is another schematic view of the real-time game play interface of FIG. 4, showing a player character attacking a non-player character.

FIG. 8 is another schematic view of the real-time game play interface pane of FIG. 4, showing a player character giving a non-player character a weapon.

FIG. 9 is a schematic view of fear states of a non-player character of the system of FIG. 1.

FIG. 10 is a schematic view of trust states of a non-player character of the system of FIG. 1.

FIG. 11 is a flowchart of a method according to one embodiment of the present invention.

### DETAILED DESCRIPTION OF THE PREFERRED EMBODIMENTS

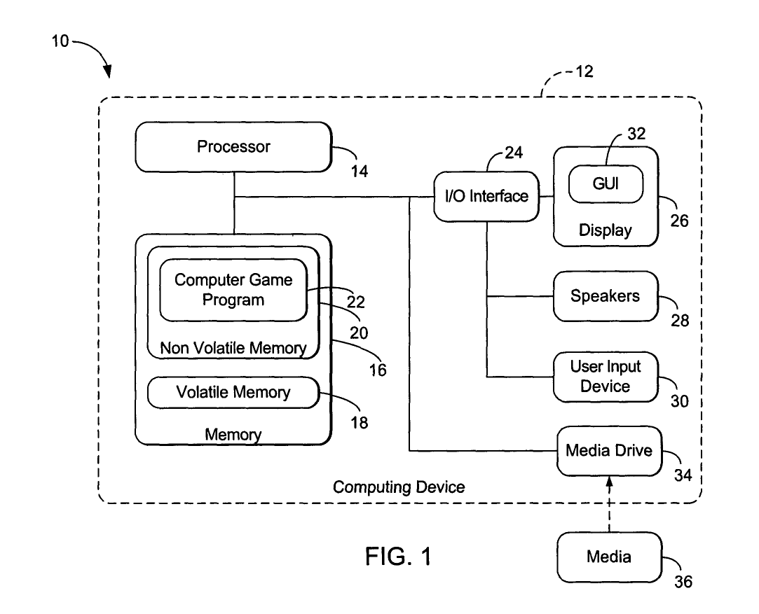

Referring initially to FIG. 1, a computer game system according to one embodiment of the present invention is shown generally at 10. System 10 typically includes a computing device 12, which is typically a personal computer but alternatively may be a portable data assistant, wireless telephone, game console, laptop, mainframe, distributed computer, or virtually any other form of computing device configured to execute computer games.

Computing device 12 typically includes a processor 14 linked by a bus to memory 16. Memory 16 typically includes volatile memory 18, such as Random Access Memory (RAM), and non-volatile memory 20, such as a hard disk, Read Only Memory (ROM), flash memory, etc. A computer game program 22 is typically stored in non-volatile memory 20 and executed by processor 14 using portions of volatile memory 18.

Computing device 12 further includes an input/output interface 24 configured to govern communication with a display 26, speakers 28, and one or more user input devices 30, such as game controllers, keyboards, computer mice, joysticks, etc. The computer game program typically displays a graphical user interface 32 on display 26, and emits corresponding audio through speakers 28.

Computing device 12 also typically further includes a media drive 34 configured to read media 36. Typically, computer game program 22 is distributed on media 36, and loaded from the media into memory 16. Suitable media types for media 30 include CD ROMs, DVD-ROMs, floppy disks, and optical disks such as those sold under the commercial name “ZIP” disks. Other suitable media types may also be used to distribute computer game program 22. It will also be appreciated that the commercial game program may be downloaded from a network server, via a computer network such as the Internet.

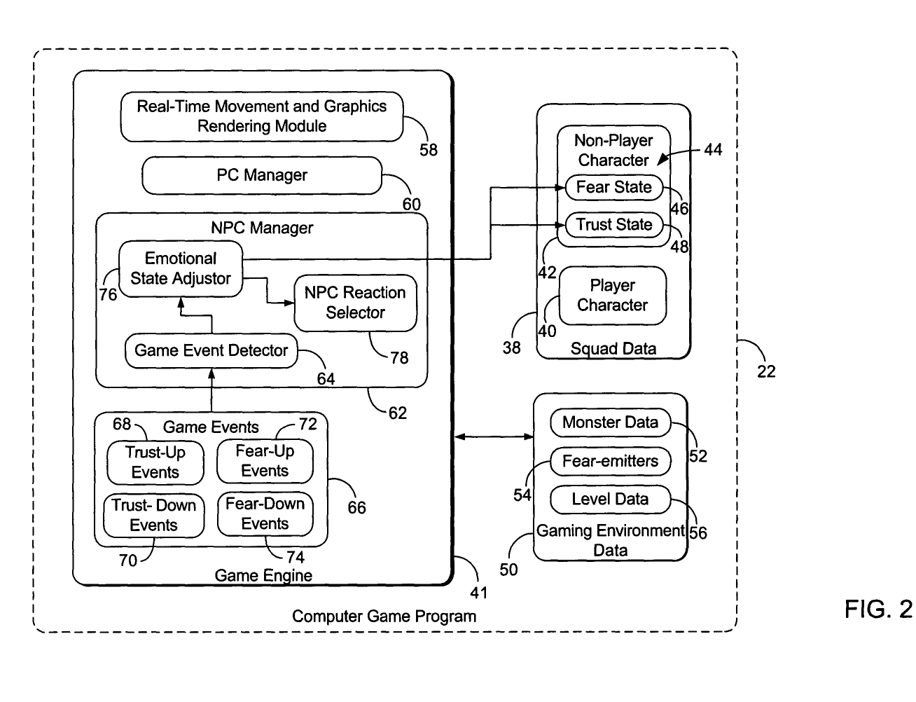

Turning now to FIG. 2, computer game program 22 is typically a squad based computer game program 22 including a game engine 41 configured to utilize squad data 38 and gaming environment data 50 to create two- or three-dimensional animated game play. Squad data 38 includes data relating to a player character 40 (PC) and one or more non-player characters 42 (NPCs) that interact to achieve objectives of the computer game. Typically, each non-player character 42 has one or more emotional states 44, which affect the reactions of the non-player character to various game events that occur during the course of the game. According to one possible embodiment of the present invention, emotional states 44 may include a fear state 46 and/or trust state 48. It will be appreciated that other suitable emotional states may be provided in addition to or instead of fear state 44 and trust state 46.

As used herein the term “player character” refers to a single character, the movements and actions of which are directly controlled in real-time by a player, via user input device 30. Normally, squad-based games have a single player mode wherein the user operates a player character, and commands a squad of one or more non-player characters. In addition, a multiplayer mode may be provided in which a plurality of users each control a separate player character, each commanding a different squad. While typically only one player character is included per squad, it will alternatively be appreciated that more than one player character may be included in each squad.

As used herein the term “non-player character” refers to a character that is controlled in real-time by the computer game program, but which may be commanded by the player character to perform certain actions. For example, the player character may command the non-player character to follow the player character, but the computer will actually control the real-time movement of the non-player character as it executes the command follows the player character.

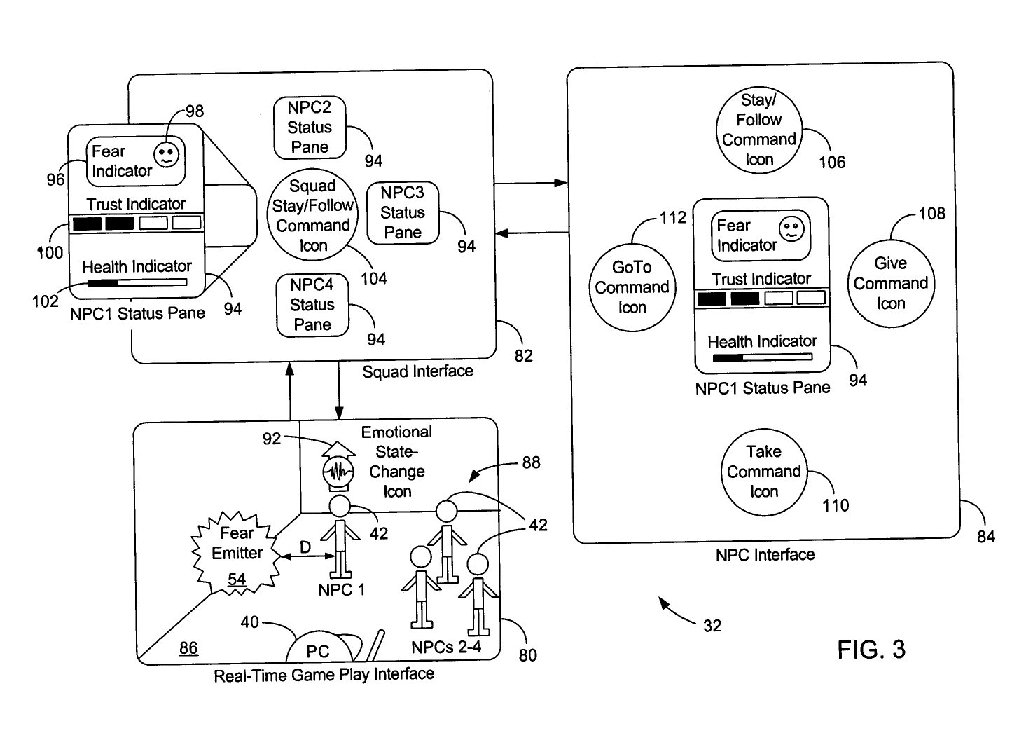

The non-player characters also may assist the player character to attack common enemies. As described in detail below, a non-player character typically only obeys commands from the player character and assists the player character in fighting common enemies when the non-player character is in an emotional state that enables them to do so, that is, when it has a sufficiently high trust level and sufficiently low fear level. This introduces an element of strategy, since the user must command the non-player characters in a manner that keeps the non-player characters' fear states low and trust states high, to enable efficient operation of the squad. Exemplary commands include follow, stay, attack, repair equipment, give weapon, take weapon, give ammunition, take ammunition, etc. These will be discussed in more detail below with reference to FIGS. 3 and 6.

Computer game program 22 also typically includes gaming environment data 50, which contains data on monsters 52, fear emitters 54, and level data 56 of computer game program 22. The term “monster” is used herein to refer to generally to enemies that are out to harm the player character and non-player characters within the game. Monsters are typically controlled by the computer and differ in several respects from non-player characters. For example, monsters are not commandable by the player character, cannot be armed and disarmed by the player character or instructed to follow the player character, do not assist the player character in attacking common enemies, and do not work with the player character to achieve goals within the computer game.

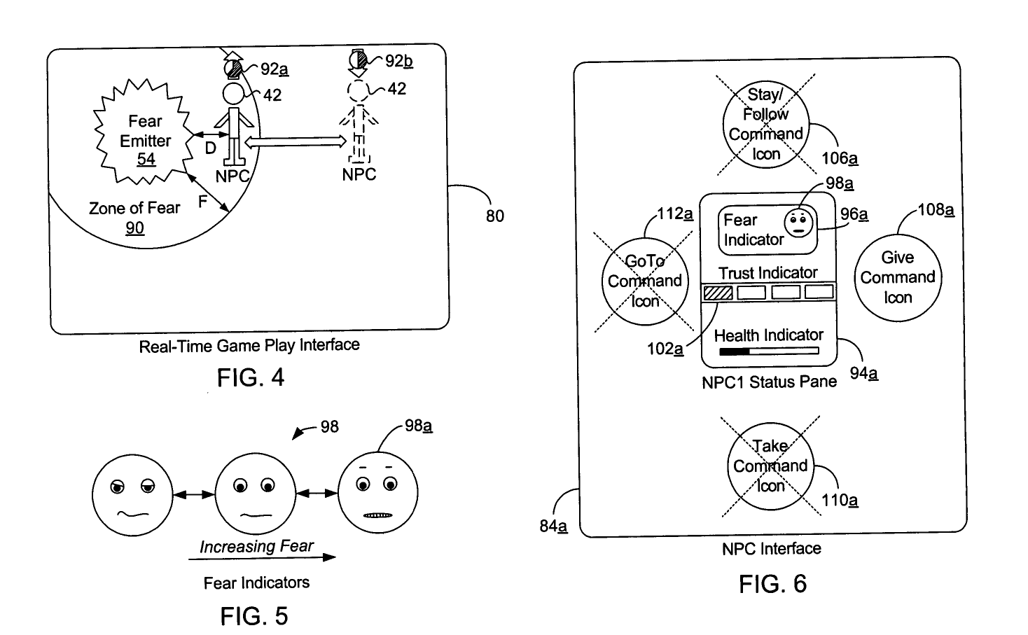

Fear emitters 54, discussed in more detail with reference to FIGS. 3 and 4, are located throughout the gaming environment (shown at 82 in FIG. 3), and cause a non-player character's fear state to rise if the non-player character is present within a predetermined threshold distance of the fear emitter. Examples of fear emitters include visible, physical objects such as certain monsters, gory scenes, and corpses, as well as sounds emitted by distant objects, such as monster screams.

Level data 56 refers to data such as maps, textures, items, etc. used to reproduce a three dimensional representation of one or more levels of the gaming environment 82 within which the player character and non-player characters interact.

Typically, game engine 41 includes a real-time movement and graphics rendering module 58 configured to position and render both non-player characters, player characters, and monsters within gaming environment 82. Game engine 41 may further include a player character manager 60 configured to manage various properties of player character 40. Game engine 38 also typically includes a non-player character manager 62 configured to manage the movement and actions of non-player characters 42.

A game event detector 64 of non-player character manager 60 is typically configured to detect predetermined game events 64 that affect an emotional state of the non-player character. One such emotion-influencing game event is an NPC being within a predetermined distance of a fear emitter. Exemplary predetermined game events 66 include trust-up events 68, trust-down events 70, fear-up events 72, and fear-down events 74. An emotional state adjustor 76 is configured to adjust an emotional state 44 of the NPC, based on the detected game event. For example, if a game event that indicates that an NPC is within a predetermined distance of a fear emitter 54, then the NPC's fear state will be raised.

NPC manager 62 also includes an NPC reaction selector 78, which is configured to select a reaction for the NPC, in response to the game event. The reaction selector typically takes a current emotional state of the NPC into account when selecting an NPC reaction. Tables 1-3, discussed below, list exemplary NPC reactions for various game events and emotional states.

As shown in FIG. 3, computer game program 22 is configured to display a real-time game play interface 80, from which a squad interface screen 82 and a non-player character interface 84 may be accessed. Real-time game play interface screen 80 typically displays game environment 86 in three-dimensions, from a perspective above and behind the player character. Alternatively, a different perspective may be used, or the game may be presented in two dimensions. A squad 88, including non-player characters 40 and at least one player character 42, typically operates in the game environment. Should an emotional state of a non-player character change, the real-time game play interface screen 80 is configured to display an emotional state-change icon 92 adjacent (typically above) the player character icon 40.

Real-time game play interface screen 80 is also configured to display a fear emitter 54. A non-player character's fear state is typically adjusted at least partially based on its proximity to fear emitter 54. As shown schematically in FIG. 4 from a top view, if a non-player character travels to a location wherein the distance D between the fear emitter 54 and the non-player character is detected as being within the predefined threshold distance F, the non-player character is deemed to be within a zone of fear 90 adjacent the fear emitter. It will be appreciated that the zone of fear may be a shape other than circular, and may be arbitrarily defined. Thus, the predetermined threshold distance F may vary based on the relative angular position of the non-player character with respect to the fear emitter. For audio fear emitters, the zone of fear 90 may be defined as the area from which the sound is audible.

Presence of the non-player character within zone of fear 90 is a fear-up event 72, which causes the non-player character's fear state to be raised. As the non-player character moves into zone of fear 90 and its fear state is raised, an emotional state change icon 92a (also referred to as a “fear-up icon”) indicating an increase in fear state appears adjacent the non-player character. If the non-player character spends a predetermined length of time within the zone of fear 90, the non-player character's fear state will again rise. For audio fear emitters, it will be appreciated that a non-player character may have its fear state raised when it hears a distant scream from a monster, for example. Movement of non-player character 42 out of zone of fear 90 is a fear-down event 74, which causes the non-player character's fear state to be lowered. Emotional state change icon 92b (also referred to as a “fear-down icon”) appears adjacent the non-player character, indicating that the character's fear state has been lowered.

FIG. 9 shows that fear states for non-player characters vary in intensity from “low” to “medium” to “danger.” Danger is further divided into “crack up level 1, ” “crack up level 2” and “crack up level 3. ” For changes between low, high, and danger fear states, a fear state-change icon is typically used which features heartbeat inspired signal iconography shown at 92 in FIG. 3. Changes between crack up levels 1-3 are typically shown via fear state-change icons similar to 92a and 92b, featuring a dial or other indicator showing the level of fear.

Each of fear state-change icons 92a, 92b includes an arrow pointing in the direction of the emotional state change, and a circular graph indicating the current value of the emotional state. Thus, the shaded portion of fear-down icon 92b is less than the shaded portion of fear-up icon 92a. Typically, the color of the arrows may be changed to correspond to new fear state. For example, a deep blue arrow may indicate a change to a low fear state, a light blue arrow to a high fear state, and a white arrow to a danger fear state.

Typically, a high or danger fear state results in a non-player character reaction that inhibits the ability of the non-player character to attack monsters and follow commands of the player character. If a non-player character's fear level rises to the crack up levels 1-3, a non-player character may exhibit a reaction such as a self destructive act (e.g. shooting wildly or attempting to take its own life, even when no weapon is possessed by the non-player character) or an act of incapacitation such as throwing up, curling up in a ball and cry, or having a heart attack.

Returning to FIG. 2, squad interface 82 is typically accessed by a predetermined command that suspends real-time game play in interface 80, and causes squad interface 82 to be displayed. Squad interface 82 includes a plurality of non-player character status panes 94, and a squad command icon 104. Squad command icon 104 commands the entire squad to perform a desired action. In the depicted embodiment, the squad command icon may be toggled by the user to alternately instruct the squad to stay in a given location, or to follow the player character.

Each non-player character status pane 94 typically includes a fear indicator 96, which typically includes a character icon 98. The character icon is typically an animated image a head of a non-player character. As shown in FIG. 5, the appearance of the character icon varies based on the fear state 46 of the non-player character. Typically, both the facial expression and the head movement are altered based on the current fear state. For example, when in the low fear state, the expression of the character appears calm and the head turns slowly from side to side. When in the high fear state, the head moves back and forth more rapidly left and right with a panicked expression. And, when in the danger fear state, the facial expression expresses even more fear, and the head moves even more rapidly looking all around. Crack up levels 1-3 further may be represented by exaggerated movements and facial expressions in the character icon 98.

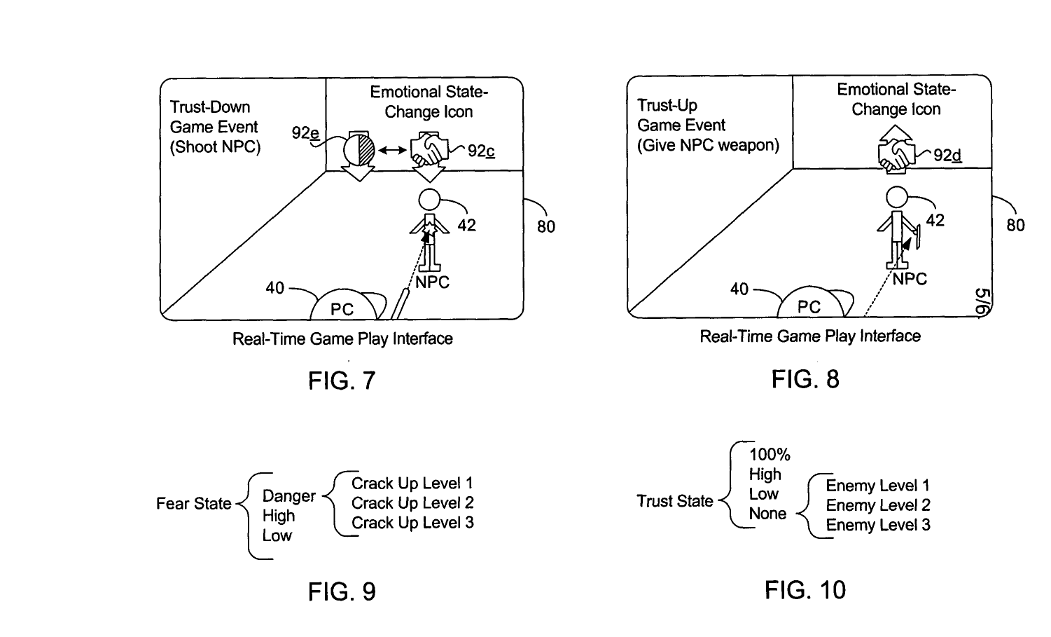

Non-player character status pane 94 further includes a trust indicator 100, which reflects the trust state 48 of non-player character 42. In the depicted embodiment a bar meter is used as an indicator, although it will be appreciated that a wide variety of indicators may be used. As shown in FIG. 10, trust state 48 typically may be 100% (or, “buddy status”), high, low, or none (“zero”). The “none” trust state is further divided into enemy level 1, enemy level 2, and enemy level 3 subdivisions. Trust indicator 100 is typically configured to indicate a 100% trust state through four green bars. A high trust state is indicated by three green bars, and a low trust state is indicated by two yellow bars. A zero trust state is indicated by a single red bar or no bar at all. Enemy levels 1-3 indicate the level of hostility shown by the non-player character toward the player character. For example, at enemy level 3, a non-player character may actively try to steal a gun to shoot the player character. Each time the non-player player transitions between one of these trust states, a pop-up emotional state change icon 92 typically appears visually indicating the transition type (“trust up” or “trust down”), as well as the newly attained trust level. Enemy levels 1-3, while not typically indicated via trust indicator 100, may be indicated via an emotional state change icon such as shown at 92e in FIG. 7, discussed below. Typically, pop-up icons emotional state change icons 92 only temporarily appear, disappearing within a few seconds after they are displayed.

Non-player character status pane 94 further includes a health level icon 102, which reflects a health level of the non-player character. As the non-player character suffers wounds while fighting monsters through the game environment 86, health points are used up and the health level decreases. Health increases as time heals these wounds, or if the non-player character receives medical care, from the player character or in another manner.

Non-player character interface 84 may be accessed by clicking on a particular non-player character status pane 94 within squad interface 82. Typically, non-player character interface 84 includes a plurality of command icons by which the player character can command the non-player character depicted in non-player character status pane 94 to perform a requested action. The command icons typically include a stay/follow command icon 106 that may be toggled to command the non-player character to follow the player character, a give weapon/ammo command icon 108 that may be selected to give either weapons or ammunition from the player character to the non-player character, a take weapon/ammo command icon 110 that may be selected to take either weapons or ammunition from the non-player character, and a repair command icon 112 that may selected to command the non-player character to repair or otherwise service a nearby piece of equipment. In FIG. 3, all command icons are available for the player character to select, because the non-player character's trust state is above a predetermined threshold value, and fear state is below a predetermined threshold value.

FIG. 6 shows a non-player character interface 84a, with a trust state 46 of “low,” and a fear state 48 of “danger.” The danger fear state is indicated by a fear indicator 96a having a fear icon 98a of a non-player character's head, showing a fearful expression and rapid back and forth movement of the head. The low trust state is indicated by a trust indicator 102a showing only one, red bar. When the fear state is above a predetermined level, and/or the trust state is below a predetermined level for a given non-player character, the ability of the player character to command the non-player character is adversely affected. These predetermined levels have been reached in the depicted interface 84a, and thus each of stay/follow command icon 106a, take command icon 110a, and repair command icon 112a is crossed out and unavailable for selection. Give command icon 108a remains selectable; typically giving weapons and ammunition to the non-player character will increase its trust state and decrease its fear state, as illustrated in the tables below. The crossed out command icons will remain unselectable until the non-player character's emotional state improves, which may be achieved, for example, by the user giving a weapon to the non-player character, or by one of the other methods for increasing fear and trust states discussed below.

In FIGS. 7-8, exemplary trust-influencing game events are depicted. FIG. 7 shows player character 40 shooting non-player character 42, which is a trust-down game event 70. In response, emotional state change icon 92c (also referred to as a “trust-down icon”) appears adjacent the non-character player. FIG. 8 shows player character 40 giving a weapon to non-player character 42, which is a trust-up game event 68. In response, emotional state change icon 92d (also referred to as a “trust-up icon”) appears adjacent the non-character player. The trust-up and trust-down icons 92c, 92d each include a pair of shaking hands, visually indicating that the trust state 48 is being affected, as well as an arrow pointing in the direction in which the trust state is being altered. The arrow may be colored based on the trust state. For example, a red arrow may indicate the trust state is changed to a low or zero trust state, a yellow arrow may indicate a change to a low trust state, and a green arrow may indicate a change to a high or 100% trust state. Once the non-player character reaches the zero trust state, as shown at 92e, a dial or other indicator may be provided in the emotional state change icon to indicate changes between enemy level 1-3.

A brief summary of these trust-influencing game events and fear-influencing game events is reprinted in Tables 1-3 below. Tables 1 and 2 each contain a list of game events to which the non-player characters are configured to react, as well as corresponding non-player character reactions, which are selected depending on a current trust or fear state of the NPC. Table 3 contains a list of generic speech that is uttered by the non-player characters in response to certain game events and detected changes in emotional state. These tables are exemplary, and are not to be considered exhaustive.

TABLE 1
Trust-State-Based Non-Player Character
Reactions to Game Events and Corresponding
Non-Player Character Reactions

| | Trust State | NPC Reactions |
|---|---|---|
| Game Events | An NPC of this | Will perform the following trust/fear influenced |
| As a reaction to . . . | trust state . . . | NPC action . . . |
| To seeing another | 100% | Will also open fire on same NPC as player is |
| non infected NPC | | shooting at |
| being shot by player | High (Green) | Will raise weapon and track NPC player is firing at |
| | Low (Amber) | Will back away from and raise weapon at NPC |
| | | being fired upon (or PC) if they come too close (and |
| | | issue “Stay away from me” speech) |
| | None (Red) | No Reaction (will continue with Red State actions) |
| To seeing another | 100% | No Reaction |
| non infected NPC | High (Green) | Will receive Trust Down |
| being killed by | Low (Amber) | Will receive Trust Down (Trust down should be big |
| player | | enough to take NPC into No Trust) |
| | None (Red) | No Reaction (will continue with Red State actions) |
| To being shot by | 100% | No Reaction |
| player when enemies | High (Green) | Will receive small Trust Down |
| are present | Low (Amber) | Will receive Trust Down |
| | None (Red) | No Reaction (will continue with Red State actions) |
| To being shot by | 100% | Will immediately drop to zero Trust (very minor |
| player when no | | time delay) and open fire on PC after issuing three |
| enemies are around | | warning icons and speech samples |
| | High (Green) | Will immediately drop to zero Trust (very minor |
| | | time delay) and open fire on PC after issuing three |
| | | warning icons and speech samples |
| | Low (Amber) | Will immediately drop to zero Trust (very minor |
| | | time delay) and open fire on PC after issuing three |
| | | warning icons and speech samples |
| | None (Red) | No Reaction (will continue with Red State actions) |
| To receiving | 100% | No (visible) Reaction (but will in fact receive the |
| Weapon | | Trust up associated with the weapon) |
| | High (Green) | Will receive Trust Up |
| | Low (Amber) | Will receive Trust Up (If the weapon has a higher |
| | | Trust value than the one currently held, or if the |
| | | NPC has no weapon) otherwise will refuse to take |
| | | weapon |
| | None (Red) | Will receive Trust Up (If the weapon has a higher |
| | | Trust value than the one currently held, or if the |
| | | NPC has no weapon) otherwise will refuse to take |
| | | weapon |
| To receiving Ammo | 100% | No (visible) Reaction (but will in fact receive the |
| | | Trust up associated with the weapon) |
| | High (Green) | Will receive Trust Up |
| | Low (Amber) | Will receive Trust Up (If the weapon has a higher |
| | | Trust value than the one currently held, or if the |
| | | NPC has no weapon) otherwise will refuse to take |
| | | weapon |
| | None (Red) | Will receive Trust Up (If the weapon has a higher |
| | | Trust value than the one currently held, or if the |
| | | NPC has no weapon) otherwise will refuse to take |
| | | weapon |
| To having weapon | 100% | Will receive Trust Down |
| and ammo taken | High (Green) | Will receive Trust Down |
| away by player | Low (Amber) | Will refuse to give weapon to player |
| | None (Red) | Will refuse to give weapon to player |
| To being healed by | 100% | Will receive Trust Up |
| player | High (Green) | Will receive Trust Up |
| | Low (Amber) | Will receive Trust Up |
| | None (Red) | Will receive Trust Up |
| To being coerced by | 100% | Will receive Trust Down after time out |
| player | High (Green) | Cannot be coerced |
| | Low (Amber) | Will receive Trust Down after time out |
| | None (Red) | Cannot be coerced |
| To seeing PC self | 100% | No (visible) Reaction (but will in fact receive Trust |
| Blood Test | | Up) |
| | High (Green) | Will receive Trust Up |
| | Low (Amber) | Will receive Trust Up |
| | None (Red) | Will receive Trust Up |
| To undertaking a | 100% | No Reaction |
| blood test | High (Green) | No Reaction |
| | Low (Amber) | No Reaction |
| | None (Red) | No Reaction |
| To receiving shot of | 100% | No Reaction (but Fear will be reduced) |
| Adrenaline | High (Green) | No Reaction (but Fear will be reduced) |
| | Low (Amber) | No Reaction (but Fear will be reduced) |
| | None (Red) | Cannot give Adrenaline |
| To seeing player kill | 100% | No (visible) Reaction (but will in fact receive a |
| Walker/Trooper/ | | Trust Up) |
| Rupture | High (Green) | Will receive Trust Up |
| | Low (Amber) | Will receive Trust Up |
| | None (Red) | Will receive Trust Up |
| To being left alone | 100% | No Reaction |
| for too long | High (Green) | Will receive Trust Down |
| | Low (Amber) | Will receive Trust Down |
| | None (Red) | No Reaction |
| To being in close | 100% | No Reaction (but Fear will be reduced) |
| proximity to other | High (Green) | No Reaction (but Fear will be reduced) |
| NPC's | Low (Amber) | No Reaction (but Fear will be reduced) |
| | None (Red) | No Reaction |
| To seeing a Gory | 100% | No Reaction (unless in High Fear State in which |
| entity (POI) | | case NPC will throw up) |
| | High (Green) | No Reaction (unless in High Fear State in which |
| | | case NPC will throw up) |
| | Low (Amber) | No Reaction (unless in High Fear State in which |
| | | case NPC will throw up) |
| | None (Red) | No Reaction |
| To seeing an enemy | 100% | Show Icon and say “Enemy Spotted” - will advance |
| | | on enemy if Fear is Low or back off if Fear is High, |
| | | will open fire if enemy is within range |
| | High (Green) | Show Icon and say “Enemy Spotted” - will advance |
| | | on enemy if Fear is Low or back off if Fear is High, |
| | | will open fire if enemy is within range |
| | Low (Amber) | Show Icon and say “Enemy Spotted” - will advance |
| | | on enemy if Fear is Low or back off if Fear is High, |
| | | will open fire if enemy is within range |
| | None (Red) | Show Icon and say “Enemy Spotted” - will advance |
| | | on enemy if Fear is Low or back off if Fear is High, |
| | | will open fire if enemy is within range |
| To being attacked by | 100% | Show Icon and play “get hit” sound |
| an enemy | High (Green) | Show Icon and play “get hit” sound |
| | Low (Amber) | Show Icon and play “get hit” sound |
| | None (Red) | Show Icon and play “get hit” sound |
| To reaching 20% or | 100% | Will show icon and play “I'm hurt bad” speech, will |
| less health “Man | | then go into knelt position until health is raised - will |
| Down” | | die after timeout if not healed |
| | High (Green) | Will show icon and play “I'm hurt bad” speech, will |
| | | then go into knelt position until health is raised - will |
| | | die after timeout if not healed |
| | Low (Amber) | Will show icon and play ”I'm hurt bad” speech, will |
| | | then go into knelt position until health is raised - will |
| | | die after timeout if not healed |
| | None (Red) | Will show icon and play “I'm hurt bad” speech, will |
| | | then go into knelt position until health is raised - will |
| | | die after timeout if not healed |
| To reaching Zero | 100% | n/a |
| Trust | High (Green) | n/a |
| | Low (Amber) | n/a |
| | None (Red) | Will ignore any further Trust Downs and will be |
| | | immune to Fear |
| To reaching Max | 100% | Will ignore any Trust influences (so level will stay |
| high fear (entering | | constant) |
| crack up) | High (Green) | Will ignore any Trust influences (so level will stay |
| | | constant) |
| | Low (Amber) | Will ignore any Trust influences (so level will stay |
| | | constant) |
| | None (Red) | Will ignore any Trust influences (so level will stay |
| | | constant) |
| To encountering | 100% | Will receive Fear Up |
| Fear emitters | High (Green) | Will receive Fear Up |
| | Low (Amber) | Will receive Fear Up |
| | None (Red) | No Reaction |
| (Trust) Idle | 100% | Check Weapon/equipment (general) |
| | High (Green) | Check Weapon/equipment (general) |
| | Low (Amber) | Will play animations of disdain to player (giving the |
| | | bird etc) or shake head and mutter under breath (can |
| | | also do general idle animations) |
| | None (Red) | No idle action |

TABLE 2
Fear-State-Based Non-Player Character
Reactions to Situations and Corresponding
Reactions, and Reactions Affecting Fear and Trust

| Situations | | |
|---|---|---|
| (Game Events) | Fear State | NPC Reactions |
| As a reaction | An NPC of this | Will perform the following trust/fear influenced |
| to . . . | fear state . . . | NPC action . . . |
| (Fear) Idle | High | Will choose randomly between: Crying, Praying or |
| | | wetting themselves |
| | Crack Up (with | Will fire randomly and then either shoot themselves |
| | weapon & ammo) | or get close to an exploding barrel and blow |
| | | themselves up or if neither are possible cower and |
| | | then Burst out after 30 seconds |
| | Crack Up (No | Will either trash any ISE's in local vicinity, Pace back |
| | weapon or ammo) | and forth in front of corpse etc whilst staring at it and |
| | | muttering or run around freaking out, then either |
| | | plunge hand into nearest junction box and electrocute |
| | | themselves or cower for 30 seconds and then burst |
| | | out |

TABLE 3
Non-Player Character Generic Speech
NPC Generic Speech

| Game Event | Speech |
|---|---|
| Player enters inner radius | “Get away from me” |
| when you are in low trust | |
| Being hit | “urgh” |
| Has no weapon | “Get me a weapon” |
| Seeing fear emitter | “woa” |
| Seeing a thing beast | “we got company” |
| Being shot by player 1st time | “Watch it!” |
| Being shot by player 3rd time | “Hold your fire!” |
| Seeing non-infected NPC | “What the hell are you doing?” |
| killed by player | |
| Seeing player inactivity | “Wake up!” |
| during combat | |
| Seeing player activity | “hey geddem” |
| during combat | |
| Accepting request 1 | “ok” |
| Accepting request 2 | “sure” |
| Refusing request (or | ”no way, I don't trust you” |
| blood test) | |
| Accepting a blood test | “All right, let's do this.” |
| Trust Up (state change) | “Maybe you will get us out of this” |
| Trust down (state change) | “what's wrong with you?” |
| Changing from low fear to | “we're gonna die here” |
| high fear | |
| Changing from high fear to | “Alright, I'm ok.” |
| low fear | |
| Changing from high fear to | “this is too much” |
| crack up stage 1 | |
| Crack up stage 2 | “This is outta control!” |
| Crack up stage 3 | “ugh ueghuugh aghhh” |
| Need medical assistance | “I'm hurt bad” |
| Given help (ammo or health) | “thanks” |
| Out of ammo | “I need ammo” |
| Unable to perform task | “I couldn't do it” |
| Enter zone where you can | “I'll take care of that” |
| offer help | |
| Red state stage 1 | “you're going to get us killed” |
| Red state stage 2 | “You must be infected” |
| Red state stage 3 | “Time's up Blake” |
| Being coerced | “ok, just don't shoot” |

According to one possible embodiment of the present invention, computer game 22 may be provided with a plot in which a virus may infect non-player characters. The virus can cause the non-player characters to turn into monsters and attack the player character. This change may happen immediately, or the virus may hibernate for some time before the non-player character is turned into a monster. The virus typically waits for an opportunity to outnumber the player character before turning a non-player character into a monster.

For example, if the player character is accompanied by two non-player characters with low fear and 100% trust levels, then there is a low probability that a virus will immediately cause a third infected non-player character to turn into a monster, because the 100% trusting non-player characters will likely turn and fire on the monster along with the player character. However, if a player character is accompanied by a non-player character with zero trust level of enemy level 3, and an infected non-player character, then the virus will likely cause the infected character to turn into a monster and start attacking the player character, in hopes the zero trust level non-player character will follow suit and attack the player character. Thus, the probability that an infected non-player character will turn into a monster is based on its trust states, and on the trust states of other non-player character squad members.

Hypodermic needles are provided in the game to give non-player characters a blood test for the virus, but if the test is positive, the non-player character will immediately turn into a monster. A self test on the player character will generally raise the trust level of non-player characters in the player character's presence.

Turning now to examples of trust-up events 68 listed in the above tables, an attack of enemies by a player character in the presence of other non-player character squad members will result in a trust up for the non-player character squad members. In addition, if a player character kills enemies in front of non-player character squad members, it will result in a trust up for the non-player character squad members.

As for trust-down events 70, if the player character shoots a non-player character squad member, the event will result in a loss of trust for the player by that non-player character squad member. If a non-player character squad member sees the player character shoot another squad member it will result in the witness losing trust in the player character. If the player character leaves a non-player character squad member for over a predetermined threshold time period it will result in a loss of trust for the non-player-character left behind. If the player character does not attack enemies in front of the non-player character squad members it will result in a loss of trust by the non-player character. If the player character stands idle with the squad members for over a predetermined threshold of time, the idleness will result in a loss of trust by the non-player character. If the player character throws grenades at squad members it will result in a loss of trust by the non-player character. If the player character attacks a non-player character squad member who is unarmed, the non-player character will rush the player character and take the weapon the player character is currently holding, and use it on the player character.

As discussed above, the player character is responsible for managing each non-player character's weapon and ammunition supply. Manipulating this can either result in loss of trust for the player character or a non-player character squad member gaining trust for the player character. Typically, giving either weapons or ammunition is a trust-up event 68 that increases the non-player character's trust level. Each weapon typically has a different value of trust. For instance, if the player character gives a non-player character squad member a pistol, the player character will gain a small amount of trust, but if the player character gives a non-player character squad member a more powerful weapon, such as a shotgun or flamethrower, the player character will gain a greater amount of trust.

If a player character takes a weapon and/or ammunition away from a non-player character, it will result in the non-player character losing trust in the player. If the player character gives a non-player character a weaker weapon when the non-player character is currently equipped with a more powerful weapon, it will result in a loss of trust for the non-player character. For example if a non-player character is equipped with a machine gun and the player character takes the machine gun away and gives the non-player character a pistol, the non-player character's trust level will be reduced.

Several items in the game can be used by the player character increase a non-player character's trust state. For example, performing a blood test on the player character in front of a non-player character squad member will increase the trust level of the non-player character, since it proves to the non-player character that the player character is not infected with a virus. In addition, using a health pack on a non-player character to increase its health level will also increase the trust level of non-player character.

Turning now to fear-influencing game events, a fear-up event 72 occurs when a non-player character sees a dead body, a dead mutated creature, or otherwise comes within a predetermined threshold distance of a fear emitter, and the non-player character will have its fear state increased. Generally, the larger the enemy the larger the amount of fear gained. To lower the fear state of a non-player character, a fear-down event 74 occurs when the player character gives weapons or ammunition to the non-player character, moves the non-player character out of a zone of fear, or administers an adrenaline hypodermic needle, which will temporarily lower the fear state of the non-player character. Further, a fear-down event 74 occurs when the player character kills an enemy in front of a non-player character. The non-player character fear state will be lowered upon the detection of any of these fear-down events.

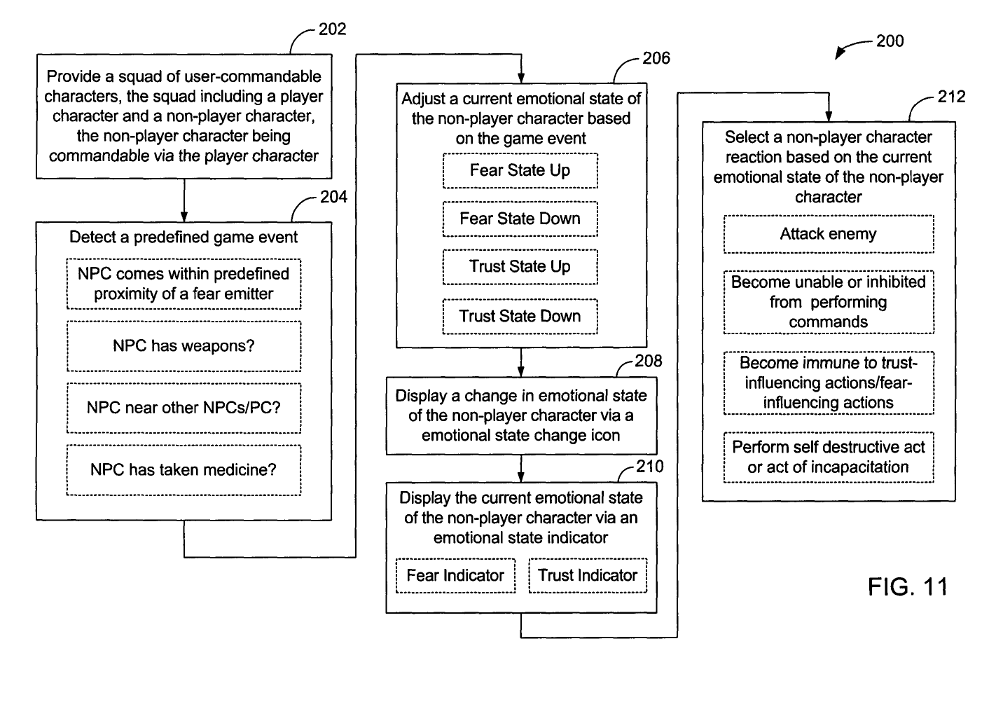

Turning now to FIG. 11, a method according to one embodiment of the present invention is shown generally at 200. The method includes, at 202, providing a squad of user-commandable characters, the squad including a player character and at least one non-player character, the non-player character being commandable via the player character. At 204, the method typically includes detecting a predefined game event. Typically, trust-influencing events such as trust-up events 68 and trust-down events 70, described above, and fear-influencing events such as fear-up events 72 and fear-down events 74, also described above, are detected.

At 206, the method typically includes adjusting a current emotional state of the non-player character based on the game event. According to one embodiment of the invention, the emotional state includes a fear state or a trust state, and adjusting is accomplished by raising or lowering the fear state or trust state, as appropriate and described in detail above. Alternatively, another suitable emotional state may be used.

At 208, the method further includes displaying a change in emotional state of the non-player character via an emotional state change icon, such as pop-up icon 92. As described above, the emotional state may be a fear state and the fear state may be indicated via a fear state-change indicator, as shown at 92a, 92b. Alternatively or in addition, the emotional state may be a trust state, and the indicator may be a trust state-change indicator, as shown at 92c, 92d, 92e.

At 210, the method typically includes displaying the emotional state of the non-player character via an emotional state indicator. As described above, the emotional state may be a fear state and the fear state may be indicated via a fear indicator such as 96, described above. In addition, the emotional state may be a trust state, and the trust state may be indicated by a trust indicator 100.

At 212, the method typically includes selecting a non-player character reaction based on the current emotional state of the non-player character. When a fear state of the non-player character is detected to be above a predetermined level, the non-player character reaction may include inhibiting the non-player character from responding to a command from the player character, performing a self-destructive act, performing an act of incapacitation, etc., as described above. Where a fear state is below a threshold level and a trust state is sufficiently high, in response to detection of an enemy or in response to seeing a player character attack an enemy, a non-player character reaction may be to or initiate or cooperate in an attack upon an enemy. Further, the non-player character reaction may include becoming unaffected by trust-influencing events upon reaching a threshold fear state, or becoming immune to fear-influencing events, upon reaching a threshold trust state. Finally, when the trust state of the non-player character is below a predetermined level, the non-player character reaction may include being unable to perform a command from the player character.

The above-described embodiments enable a computer game user to command a squad of non-player characters via a player character and experience emotion-based character interactions, resulting in a challenging and enjoyable gaming experience, far superior to prior squad-based games.

Although the invention has been disclosed in its preferred forms, the specific embodiments thereof as disclosed and illustrated herein are not to be considered in a limiting sense, because numerous variations are possible. The subject matter of the invention includes all novel and non-obvious combinations and subcombinations of the various elements, features, functions, and/or properties disclosed herein.

1. A method for controlling a non-player character in a computer game, the method comprising:
providing a squad of user-commandable characters, the squad including a player character and at least one non-player character, the non-player character being commandable via the player character;
detecting a predefined game event;
adjusting a current emotional state of the non-player character based on the game event; and
selecting a non-player character reaction based on the current emotional state of the non-player character.

2. The method of claim 1, wherein movement of the player character is controlled by direct user input from a user input device, and movement of the non-player character is controlled by the computer game program.

3. The method of claim 1, wherein the emotional state is a fear state.

4. The method of claim 3, the method further comprising, adjusting the fear state of the non-player character based on the non-player character's proximity to a fear emitter.

5. The method of claim 4, wherein detecting the predefined game event includes detecting that the non-player character has come within a predefined distance of a fear emitter, and wherein adjusting the fear state includes increasing the fear state if the player is within the predefined distance.

6. The method of claim 4, wherein detecting the predefined game event includes detecting that the NPC has moved beyond a predefined distance from the fear emitter, and wherein adjusting the fear state includes decreasing the fear state if the player is beyond the predefined distance.

7. The method of claim 3, further comprising, adjusting the fear state of the non-player character based on the non-player character's proximity to other squad members.

8. The method of claim 7, wherein the game event is the non-player character being left alone by the player-character for greater than a predetermined period of time, and wherein adjusting the emotional state includes increasing the fear state of the non-player character.

9. The method of claim 7, wherein the game event is the non-player character being in the presence of other non-player character squad members, and where adjusting the emotional state includes reducing the fear state of the non-player character.

10. The method of claim 3, further comprising, adjusting the fear state of the non-player character based on the non-player character's possession of weapons or ammunition.

11. The method of claim 10, wherein the game event is the player character giving a weapon or ammunition to the non-player character, and wherein adjusting the emotional state includes decreasing the fear state of the non-player character.

12. The method of claim 10, wherein the game event is the player character taking a weapon or ammunition from the non-player character, and wherein adjusting the emotional state includes increasing the fear state of the non-player character.

13. The method of claim 3, further comprising, adjusting the fear state of the non-player character based on medicine received by the non-player character.

14. The method of claim 4, further comprising, displaying the fear state of the non-player character via a fear indicator on a GUI of the computer game.

15. The method of claim 4, further comprising, inhibiting the non-player character from responding to a command from the player character, when the fear state is above a predetermined level.

16. The method of claim 1, wherein the non-player character reaction includes a self-destructive act.

17. The method of claim 1, wherein the non-player character reaction includes an act of incapacitation.

18. The method of claim 3, wherein the emotional state further includes a trust state, the method further comprising causing the non-player character to become immune to fear-influencing events upon reaching a predetermined trust state.

19. The method of claim 3, wherein the non-player character reaction includes attacking an enemy when the fear state is at or below a threshold fear state.

20. The method of claim 1, wherein the emotional state is a trust state.

21. The method of claim 20, wherein detecting the predefined game event includes detecting the occurrence of a trust-influencing event.

22. The method of claim 21, wherein the trust-influencing event is a trust-down event, configured to lower a current trust state of the non-player character.

23. The method of claim 22, wherein the trust-down event includes a player character taking away weapon from a non-player character.

24. The method of claim 22, wherein the trust-down event includes a player character taking away ammunition from a non-player character.

25. The method of claim 22, wherein trust-down event includes a player character attacking a non-player character.

26. The method of claim 22, wherein trust-down event includes player character leaving a non-player character alone.

27. The method of claim 21, wherein the trust-influencing event includes a trust-up event.

28. The method of claim 27, wherein the trust-up event includes a player character giving a non-player character a weapon.

29. The method of claim 28, wherein the trust state of the non-player character is raised if the weapon is better than a weapon formerly possessed by the non-player character, and is lowered if the weapon is worse than formerly possessed by the non-player character.

30. The method of claim 27, wherein trust-up event includes a player character healing the non-player character.

31. The method of claim 27, wherein trust-up event includes a player character subjecting itself to a medical examination, in a vicinity of a non-player character.

32. The method of claim 27, wherein trust-up event includes a player character attacking a monster in a vicinity of non-player character.

33. The method of claim 20, wherein the non-player character reaction includes being unable to perform a command from the player character when the trust state of the non-player character is below a predetermined level.

34. The method of claim 20, wherein the emotional state further includes a fear state, and wherein the non-player character reaction includes becoming unaffected by trust-influencing events upon reaching a threshold fear state.

35. The method of claim 20, wherein the non-player character reaction includes attacking an enemy when the trust state is at a threshold trust state.

36. A computer game system for emotion-based character interaction, the system comprising, a computer game program having:
a module configured to control movement for a squad of user-commandable characters, the squad including a player character and at least one non-player character, the non-player character being commandable via the player character; and
a non-player character module including:
a game event detector configured to detect a predefined game event;
an emotional state adjustor configured to adjust a current emotional state of the non-player character based on the game event; and
a non-player character reaction selector configured to select a non-player character reaction based on a current emotional state of the non-player character.

37. Computer readable media having instructions stored thereon, which when executed by a computing device, cause the computing device to perform a method comprising the steps of:
providing a squad of user-commandable characters, the squad including a player character and at least one non-player character, the non-player character being commandable via the player character;
detecting a predefined game event;
adjusting a current emotional state of the non-player character based on the game event; and
selecting a non-player character reaction based on the current emotional state of the non-player character.
